(19) United States
(12) Patent Application Publication
(10) Pub. No.: US 2002/0055746 A1
(43) Pub. Date: May 9, 2002

(54) Method and apparatus for extracting foreign bodies from nasal passages and the like

(76) Inventors: Alan Burke, Montgomery, TX (US); Micah Tomlinson, Montgomery, TX (US)

Correspondence Address: Hugh R. Kress, 2400 Bank One Center, 910 Travis Street, Houston, TX, 77002, US

(21) Appl. No.: 10/004,435

(22) Filed: Oct. 22, 2001

Related U.S. Application Data
(60) Provisional application No. 60/245,612, filed on Nov. 3, 2000.

(51) Int. Cl. A61D 1/12

(52) U.S. Cl. 606/106

(57) ABSTRACT

A method and apparatus for extracting foreign objects from the nasal passageway of a patient. In one embodiment, the apparatus comprises a flexible, elongate body having an inflatable balloon segment disposed at a distal end thereof. A method of practicing the invention involves introducing the distal end of the elongate body into the patient's nasal passageway to an extent that the balloon segment is advanced beyond the location in the nasal passageway at which the foreign body has become lodged. The balloon is then inflated. When the apparatus is withdrawn from the nasal passageway, the balloon draws the foreign object along and out of the nasal passageway. In one embodiment, the extraction apparatus is manufactured using methods and materials of a character that it is practical and cost-effective to render the apparatus disposable.

### RELATED APPLICATIONS

This application claims the priority of prior provisional application Serial No. 60/245,612 filed on Nov. 3, 2000, which application is hereby incorporated by reference herein in its entirety.

### FIELD OF THE INVENTION

The present invention relates generally to the medical arts, and more particularly to a method and apparatus for extracting foreign bodies from patients' noses and the like.

### BACKGROUND OF THE INVENTION

Medical practitioners are not infrequently faced with situations in which a foreign object has become lodged within a patient's nose. Children in particular are prone to insert small objects, such as buttons, beads, and the like, into their noses. Of course, in such situations, it is very important that the foreign object be removed.

Various techniques and apparatuses are known for facilitating the removal of a foreign object from a nasal passage. A common approach involves the use of a speculum to provide access to the foreign object and extraction of the object using forceps, suction, or insufflation. In U.S. Pat. Nos. 5,938,590 and 6,001,059 to Elliott, for example, there is proposed a speculum extension with a sidearm thereon connectable to a vacuum source. The open distal end of the speculum extension is adapted to be inserted into the nose, such that upon application of the vacuum, the foreign object is drawn out of the nasal passage as the speculum is withdrawn.

While the various known techniques for extraction of foreign objects from nasal passages and the like may be satisfactory to varying degrees, it is believed that there is room for improvement in the efficacy, ease, safety, and painlessness of foreign object extraction.

### SUMMARY OF THE INVENTION

Accordingly, the present invention is directed in one aspect to a method and apparatus for extraction of a foreign object from a patient's nose. In one embodiment, the apparatus comprises an elongate balloon catheter-like apparatus. The inflatable “balloon” end of the apparatus is adapted for insertion of a distal end thereof into a patient's nasal cavity to an extent that the balloon is advanced through the nasal passage beyond the point at which the foreign object is lodged. Thereafter, the balloon is inflated through means disposed on and actuated at the proximal end of the apparatus, expanding the balloon at the distal end in conformance with the diameter of the nasal passage. Then, the apparatus body is withdrawn from the nasal passage. The foreign object is pulled out of the nasal passage by the inflated balloon.

In an alternative embodiment of the invention, a balloon catheter-like apparatus is provided with a lumen throughout its length to function as an air passageway through the catheter. The lumen enhances a patient's ability to breathe during the process of extracting a foreign objection from the nasal passage.

### BRIEF DESCRIPTION OF THE DRAWINGS

The foregoing and other features and aspects of the present invention will be best understood with reference to the following a detailed description of a specific embodiment of the invention, when read in conjunction with the accompanying drawings, wherein:

FIG. 1 is a perspective view of a nasal extraction apparatus in accordance with one embodiment of the invention with a balloon-like inflatable portion at a distal end thereof in a deflated state;

FIG. 2 is a perspective view of the nasal extraction apparatus from FIG. 1 with the balloon-like inflatable portion in an inflated state;

FIG. 3 is a side cross-sectional view of a patient's head showing the nasal extraction device being inserted into the patient's nasal cavity;

FIG. 4 is a side cross-sectional view of a patient's head showing the distal end portion of the apparatus from FIG. 1 in an inflated state after insertion into the patient's nasal cavity;

FIG. 5 is a perspective view of a nasal extraction apparatus in accordance with an alternative embodiment of the invention;

FIGS. 6a and 6b are side views of a nasal extraction apparatus in accordance with another alternative embodiment of the invention;

FIGS. 7a and 7b are side views of a nasal extraction apparatus in accordance with still another alternative embodiment of the invention;

FIG. 8a is a side view of a nasal extraction apparatus in accordance with still another alternative embodiment of the invention, and FIG. 8b is an enlarged side view of a distal end of the apparatus from FIG. 8a; and

FIGS. 9a and 9b are side views of a nasal extraction apparatus in accordance with still another alternative embodiment of the invention.

### DETAILED DESCRIPTION OF SPECIFIC EMBODIMENTS OF THE INVENTION

In the disclosure that follows, in the interest of clarity, not all features of actual implementations are described. It will of course be appreciated that in the development of any such actual implementation, as in any such project, numerous engineering and design decisions must be made to achieve the developers' specific goals and subgoals, which will vary from one implementation to another. Moreover, attention will necessarily be paid to proper clinical, engineering and design practices for the environment(s) in question. It will be appreciated that such a development effort might be complex and time-consuming, but would nevertheless be a routine undertaking for those of ordinary skill in the relevant fields.

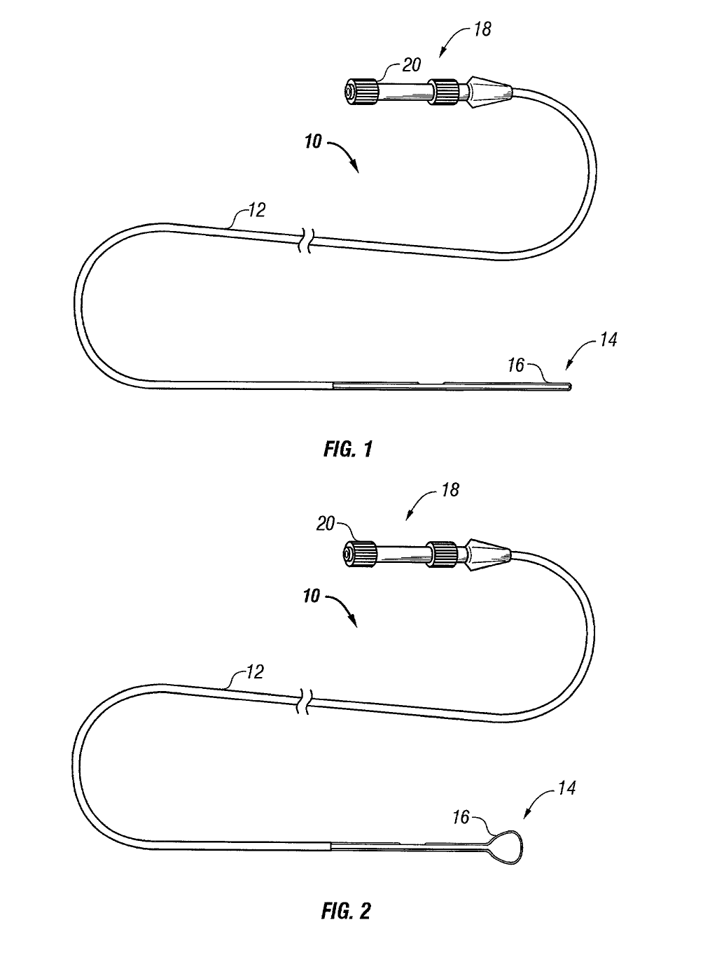

Referring to FIG. 1, there is shown a depiction of a balloon catheter-like extraction apparatus 10 in accordance with one embodiment of the invention. As can be seen in FIG. 1, extraction apparatus 10 comprises an elongate body 12 made of, for example, polyurethane, polyethylene, polyethersulfone, or other elastomeric materials known in the art to be suitable for such purposes (see, e.g., U.S. Pat. No. 5,074,845 to Miraki et al., entitled “Catheter With Heat Fused Balloon With Waist,” which discloses various methods and materials for manufacturing balloon catheters, and which is hereby incorporated by reference herein in its entirety).

Elongate body 12 is hollow, having an elongate lumen defined along its longitudinal axis between proximal and distal ends of body 12. At a distal end 14 of elongate body 12 is a balloon segment 16 adapted to be inflated when pneumatic pressure, such as from a gas or liquid is injected into the central lumen of elongate body 12 at a proximal end 18. An inflation port 20 is provided for coupling elongate body 12 to a source of pneumatic pressure, for example, a syringe or the like (not shown) in a conventional manner.

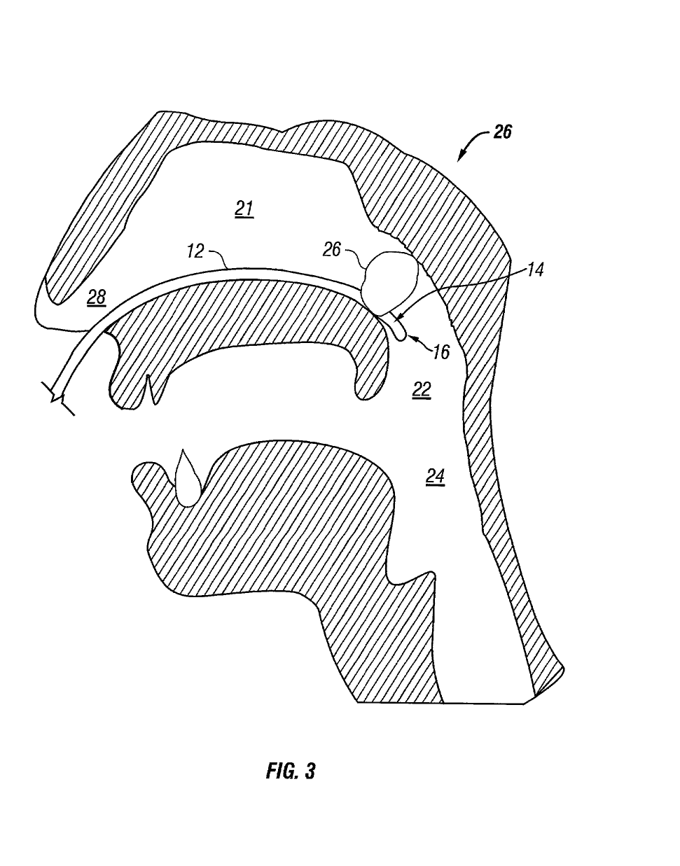

In FIG. 2, extraction apparatus 10 is shown with balloon segment 16 inflated. Balloon segment 16 may be made of an ethylene vinyl acetate or another copolymer known to be suitable for such purposes.

Referring to FIG. 3, the manner in which apparatus 10 may be employed to dislodge a foreign object from a patient's nose is described with reference to a cut-away view of the nasopharyngeal space comprising the nasal cavity 21, nasopharynx 22, and oropharynx 24 of a patient 26. FIG. 3 shows a foreign object 26 lodged in the nasal passageway in the vicinity of the nasopharynx 22. To use apparatus 10 to dislodge and extract foreign object 26, the distal end 14 thereof is fed into the nasal passageway through the nostril 28 and nasal cavity 21 and proceeding until distal end 14 comprising balloon segment 16 is maneuvered past foreign object 26 as shown in FIG. 3.

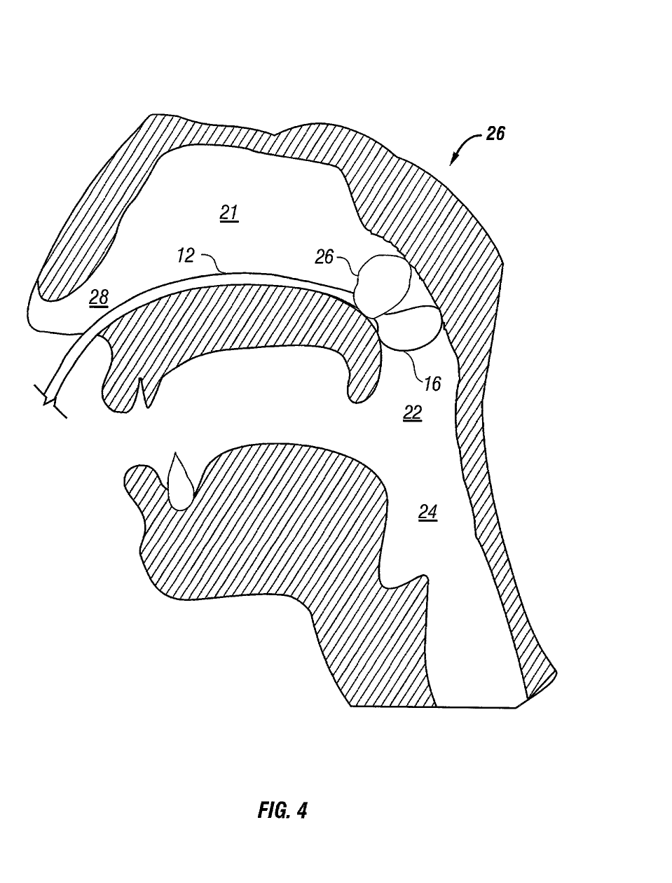

Turning to FIG. 4, after apparatus 10 has been inserted as shown in FIG. 3, balloon segment 16 is inflated as described above. As is apparent from FIG. 4, once balloon 16 has been inflated, foreign object 26 can be extracted from the nasal passageway by simply withdrawing apparatus 10 out of the nostril 28, with inflated balloon segment 16 pulling foreign object 26 out of the passageway from behind.

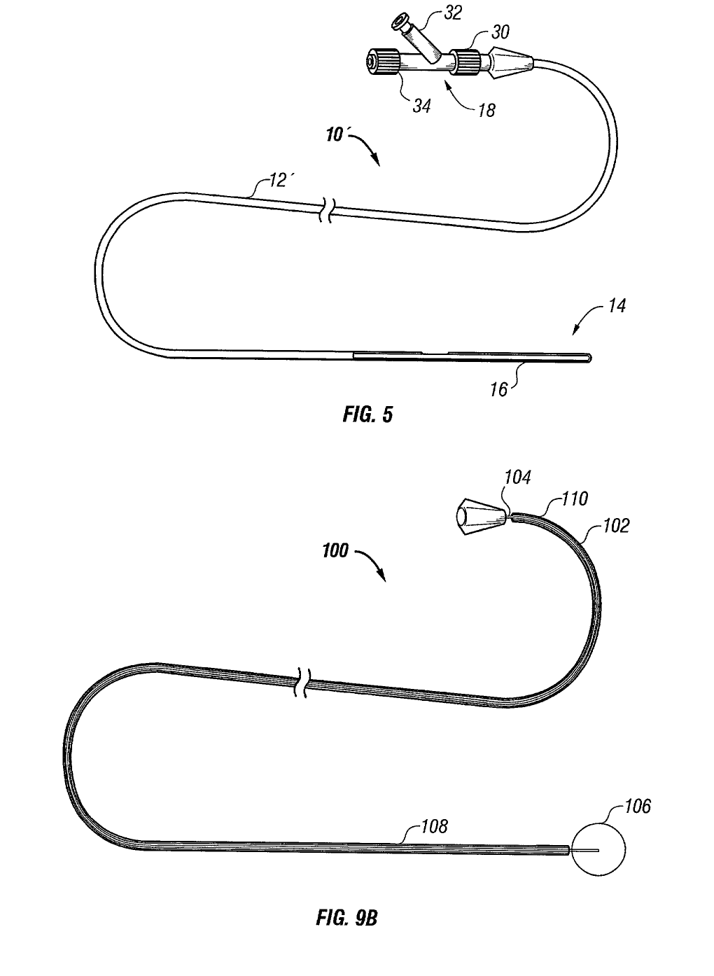

In FIG. 5, there is shown an alternative embodiment of the invention, wherein elements of a extraction apparatus 10′ which are identical to those of apparatus 10 in FIGS. 1 and 2 have retained identical reference numerals. In the embodiment of FIG. 5, elongate body 12′ has two separate lumens defined therein. Dual lumen catheters and the like are well-known in the art, and examples can be noted in the aforementioned Miraki '845 patent.

With a dual-lumen catheter body 12′, a first lumen is used for the purposes of inflating balloon segment 16, while a second lumen may serve to provide at least limited infusion of air through elongate body 12′, enhancing the patient's ability to breathe even during the process of extracting a foreign body. To facilitate the use of both lumens, a modified hub 30 is provided at the proximal end of 18 apparatus 10′, with separate ports 32, 34 for inflating balloon 16 and providing airflow to the patient, respectively.

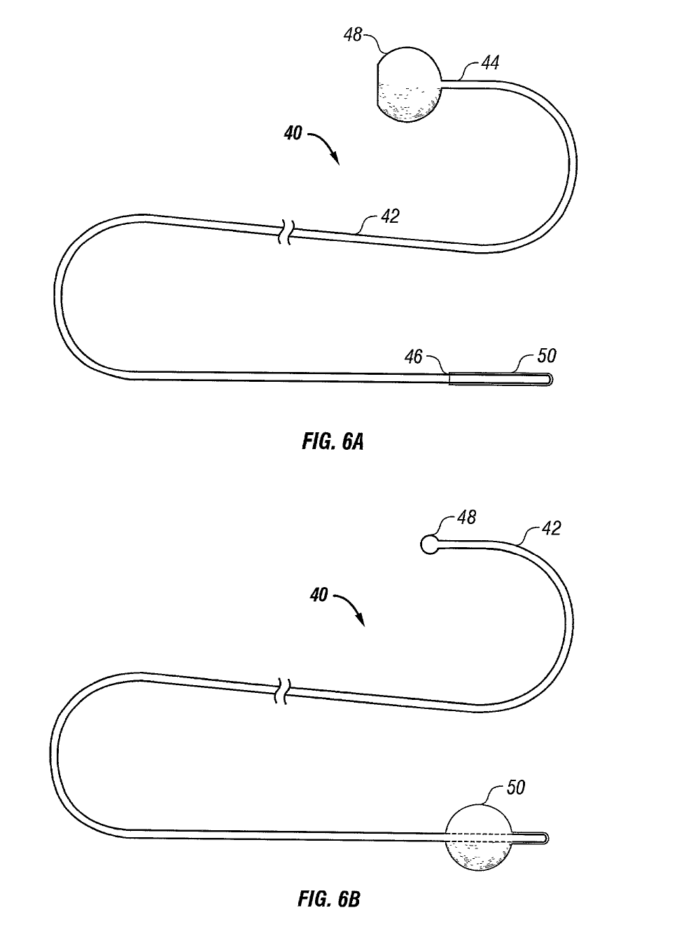

Turning now to FIGS. 6a and 6b, there is shown a foreign body extraction apparatus 40 Ad in accordance with still another embodiment of the invention. As shown in FIGS. 6a and 6b, apparatus 40 comprises an elongate body portion 42 having a proximal end 44 and a distal end 46. As in previous embodiments, elongate body 42 defines a lumen therein for establishing a path of fluid communication between proximal end 44 and distal end 46. In the embodiment of FIGS. 6a and 6b, a manually-actuable pump 48 (alternatively referred to as a reservior) is provided. Preferably, pump 48 is integral with body 42, and may take the form of a squeezable bulb, as shown in FIG. 6a. Also, pump 48 preferably is made of a material, such as rubber or the like, which tends to keep pump in its inflated state, as shown in FIG. 6a.

On distal end 46, an inflatable balloon 50 is provided as in previous embodiments. Balloon 50 is shown in a deflated state in FIG. 6a. Apparatus 40 is operated in a manner substantially similar to that of previous embodiments. In particular, when used to dislodge and extract a foreign object from a patient's nasal cavity, distal end 46 is introduced into the nasal cavity with balloon 50 in the deflated state of FIG. 50. Once balloon 50 becomes positioned beyond the nasal obstruction, pump 48 is actuated, as by squeezing, thereby forging air therein along the lumen of body portion 42 to inflate balloon 50, as is shown in FIG. 6b. Apparatus 40 is then withdrawn from the nasal cavity, with inflated balloon 50 tending to pull the obstruction out of the nasal cavity. Upon removal of apparatus 40 from the nasal cavity, pump or reservior 48 is deactuated, thereby returning to the state shown in FIG. 6a. This withdraws air through the lumen of body portion 42, thereby deflating balloon 50.

The embodiment of FIGS. 6a and 6b has the advantage of being self-contained, and is preferably intended to be disposable, thereby minimizing or eliminating sterility issues associated with re-use.

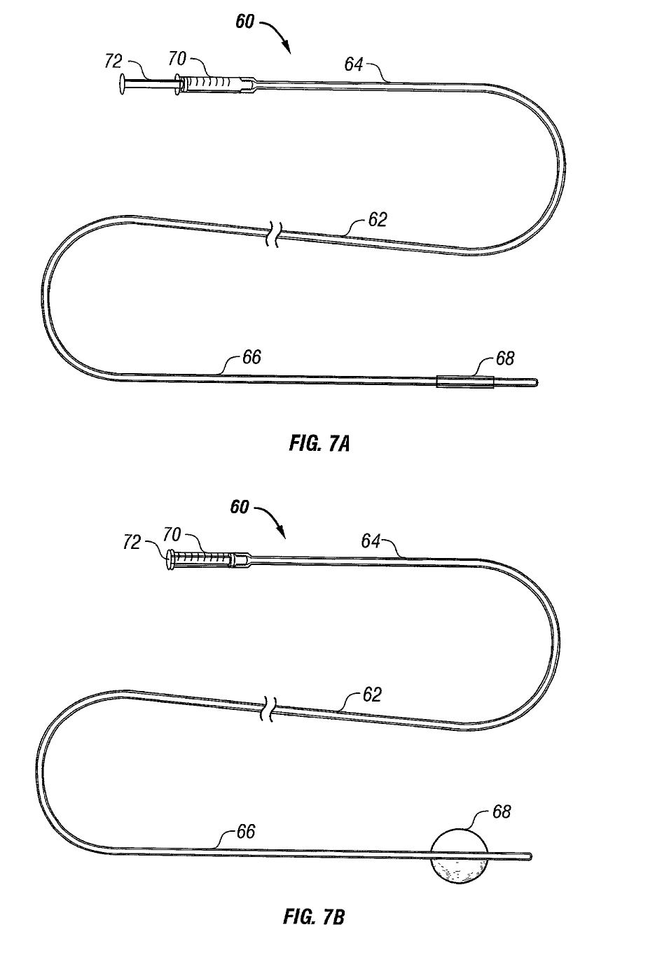

In FIGS. 7a and 7b, still another alternative embodiment of the invention, designated with generally with reference numeral 60 is shown. Apparatus 60 comprises an elongate body portion 62 having a proximal end 64 and a distal end 66. As in previous embodiments, the embodiment of FIGS. 7a and 7b incorporates an inflatable balloon 68 at distal end 66. In this embodiment, distal end 64 is adapted to have a conventional syringe (with no needle) 70 inserted therein. To utilize apparatus 60, distal end 68 is advanced into the patient's nasal cavity as in previous embodiments, with plunger 72 at least partially withdrawn out of syringe 70, as shown in FIG. 7a. After desired placement of balloon 68 beyond the point of nasal obstruction, plunger 72 is advanced into syringe 70, thereby causing balloon 68 to inflate.

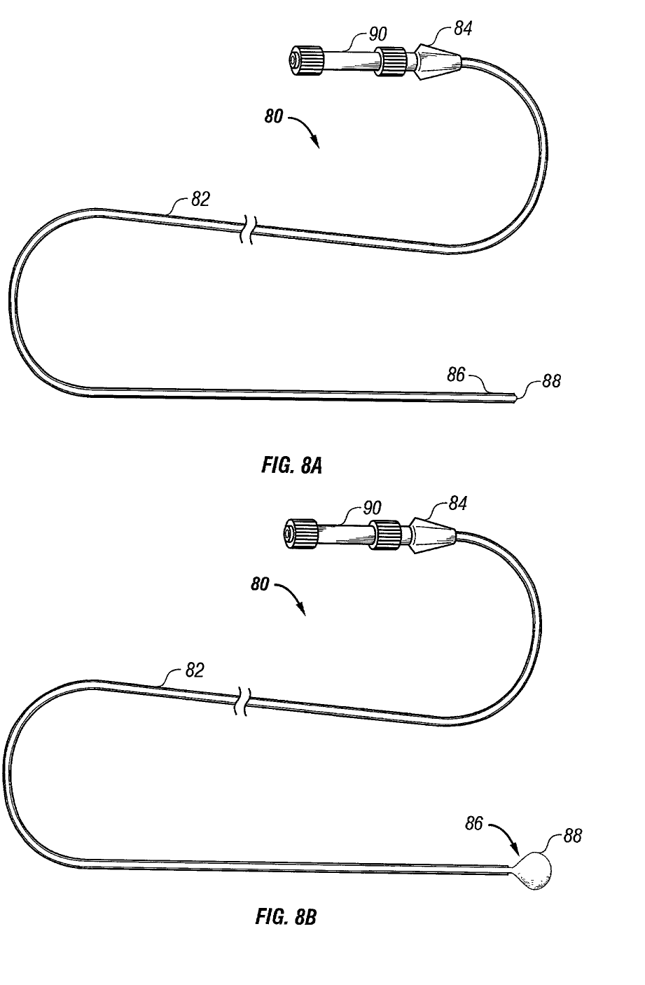

Turning now to FIG. 8a, there is shown still another alternative embodiment of the invention, designated with reference numeral 80. Apparatus 80 comprises an elongate body 82 having proximal and distal ends 84 and 86, respectively. In the embodiment of FIG. 8a, elongate body 82 is hollow, having a lumen extending between proximal and distal ends 84 and 86. Referring to FIG. 8b, which is an enlarged view of distal end 86 of body 82, the inner wall of the lumen has an elastic lining 88 affixed thereto.

As shown in FIG. 8a, an inflation port 90 is disposed at the proximal end 84 of body 82. Inflation port 90 is substantially the same as inflation port 20 in the embodiment of FIG. 1, and allows for the injection of air (or another fluid) into the lumen of body 82. To utilize apparatus 80, distal end 86 is advanced into the patient's nasal cavity as in previous embodiments. Upon desired placement of distal end 86, air is injected into the lumen of body 82 via inflation port 90. This causes elastic lining 88 to inflate out of the distal end 86 of body 82, as depicted in FIG. 8b, in an essentially balloon-like manner.

Although the embodiment of FIGS. 8a and 8b is shown with an inflation port 90 to allow for inflation at distal end 86, those of ordinary skill in the art will appreciate that various other arrangements for facilitating inflation at the distal end 86 may be employed, including, for example, the pump 48 as described above with reference to the embodiment of FIGS. 6a and 6b.

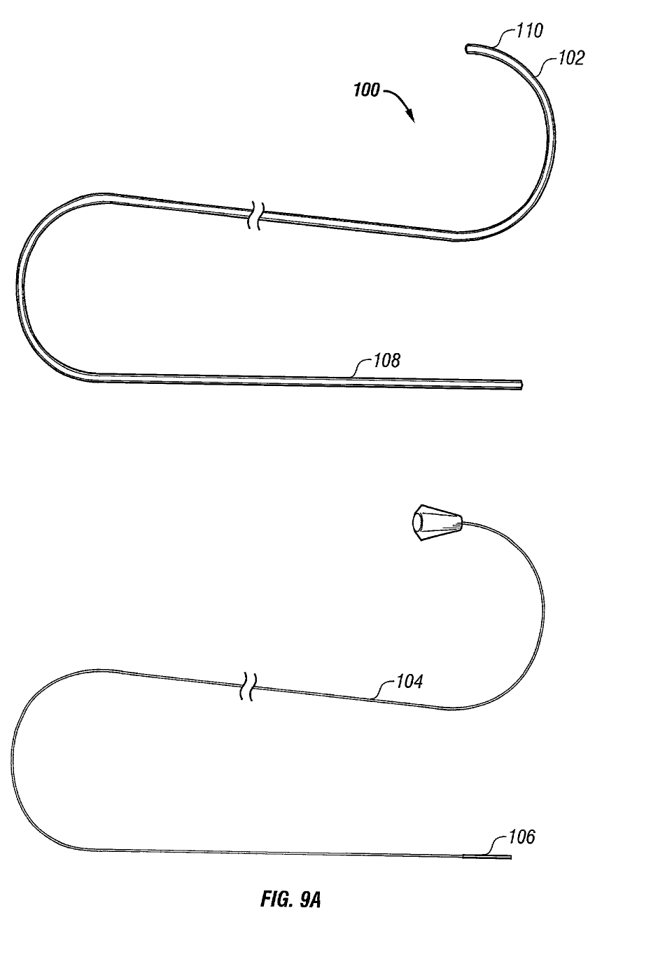

Turning now to FIGS. 9a and 9b, there is shown still another alternative embodiment of the invention, a nasal extraction apparatus designated generally with reference numeral 100. Apparatus 100 comprises two primary components: an elongate, hollow flexible outer sheath 102, and an elongate balloon assembly 104. Balloon assembly 104 has an inflatable balloon 106 disposed at a distal end thereof, and means 108 for inflating balloon 106 disposed at a proximal end thereof. It is contemplated that the inflation means 108 can comprise any of the various alternatives described herein (i.e., an inflation port as in the embodiments of FIGS. 1 and 8a, a pump 48 as in the embodiment of FIG. 6a, a syringe as in the embodiment of FIG. 7a, and so on.) To utilize apparatus 100, first a distal end 108 of sheath 102 is advanced into the patient's nasal cavity to a point beyond the nasal obstruction. Thereafter, balloon assembly is inserted into the proximal end 110 of sheath 102 and advanced through sheath 102 until balloon 106 advances out beyond the distal end 108 of sheath 102. Balloon 106 is then inflated by an appropriate means from the proximal end thereof. Then, sheath 102 and balloon assembly 106 are together withdrawn from the patient's nose, with balloon 106 serving to pull the obstruction out.

In any embodiment of the invention described herein, the inflated diameter of balloon segment can be adjusted in a conventional manner depending upon where in the nasal passageway the foreign body has become lodged.

It is to be noted that although balloon catheters are relatively well-known in the medical arts, it has not heretofore been proposed to utilize a balloon catheter-like apparatus for the purposes of extracting foreign objects from a patient's nasal passageway as disclosed herein. The invention has numerous advantages and benefits over prior art methods and apparatuses for extracting foreign bodies from nasal cavities, including that the apparatus may be manufactured using methods and materials of such character as to make it disposable, advantageously eliminating the need for sterilization between uses and at the same time minimizing the risk of patient infection. This is in contrast to conventional methods and apparatuses for extraction of foreign bodies from nasal passages and the like, such as proposed in the above-referenced '059 and '590 patents to Elliott.

As would be appreciated by those of ordinary skill in the art, the materials and manufacturing processes for conventional balloon catheters and the like are selected to render them suitable for subjecting to sterilizing techniques; the use of such materials and methods renders most conventional catheters quite expensive, making it impractical to regard them as disposable. The invention is advantageously practiced in the context of, for example, a pediatric emergency room setting where young patients with foreign objects in their noses are often found.

From the foregoing detailed description of a specific embodiment of the invention, it should be apparent that a method and apparatus for extracting foreign objects from patient's noses has been disclosed. Although specific embodiments of the invention have been disclosed herein in some detail, this has been done solely for the purposes of illustrating various aspects and features of the invention, and is not intended to be limiting with respect to the scope of the invention. It is contemplated that numerous substitutions, alterations, modifications and/or additions, including but not limited to those design alternatives which might have been specifically noted in this disclosure, may be made to the disclosed embodiments without departing from the spirit and scope of the invention as defined in the claims.

Among the variations of the invention contemplated by the inventors is the selection of materials from which the various components of the apparatuses disclosed herein might be composed. Preferably, as would be appreciated by those of ordinary skill in the art, elongate body portions are, although flexible, sufficiently rigid to allow it to be fed through a patient's nasal passageway and extended beyond a foreign object lodged in the patient's nose. As a further alternative, the elongate body portion may be adapted to receive a stiffening guidewire therein, providing the elongate body with suitable rigidity while being introduced into the patient's nose. For the purposes of withdrawing the extraction apparatus 10 while providing the least discomfort to the patient, such a guidewire would preferably be removed prior to withdrawal of the apparatus.

Another possible design variation relates to the selection of materials from which the balloon segment may be made. Although balloon catheters having balloons of various compositions are known, such compositions are typically selected based upon the use of the catheter in conventional ways, for example, transvenously, for which particular characteristics of the material are critical for reasons not applicable to the present invention. It is contemplated that an extraction apparatus in accordance with the present invention may have a balloon segment made of a material which might be deemed undesirable for prior art catheter applications. For example, a balloon segment may be made of a material adapted to withstand puncture to a greater extent than prior art catheters, so as to minimize the risk of puncture when inflated in proximity to a foreign object, which might have a sharp edge or the like.

What is claimed is:

1. An apparatus for extracting a foreign object lodged in a patient's nasal passageway, comprising:
a flexible, elongate body having proximal and distal ends;
an inflatable balloon segment disposed generally at said distal end of said elongate body;
an inflation port disposed at said proximal end of said elongate body in pneumatic communication with said inflatable balloon segment;
wherein said distal end of said elongate body is adapted to be inserted into said patient's nasal cavity such that said inflatable balloon segment is positioned beyond said foreign object;
and wherein said inflation port is adapted to receive a source of pneumatic pressure to inflate said balloon segment;
and wherein said elongate body is adapted to be withdrawn from said patient's nasal passageway upon inflation of said balloon segment, thereby dislodging said foreign object from said patient's nasal passageway.

2. An apparatus in accordance with claim 1, wherein said elongate body is made of an elastomeric material.

3. An apparatus in accordance with claim 2, wherein said balloon segment is integral with said elongate body.

4. An apparatus in accordance with claim 3, wherein said balloon segment is made of ethylene vinyl acetate.

5. An apparatus in accordance with claim 1, wherein said elongate body has a first lumen extending along the length thereof providing pneumatic communication between said inflation port and said balloon segment.

6. An apparatus in accordance with claim 5, wherein said elongate body has a second lumen extending along the length thereof providing a conduit for the flow of air into the patient's nasal cavity.

7. An apparatus in accordance with claim 5, wherein said elongate body has a second lumen extending along the length thereof adapted to receive a stiffening guidewire therein.

8. A method of extracting a foreign object lodged in the nasal cavity of a patient, comprising:
(a) inserting a distal end of a elongate extraction apparatus into said patient's nasal passageway such that an inflatable balloon segment disposed on said distal end is positioned beyond said foreign object;
(b) inflating said inflatable balloon segment through application of pneumatic pressure at an inflation port disposed near the proximal end of said elongate extraction apparatus;
(c) withdrawing said extraction apparatus from said patient's nasal passageway, thereby dislodging said foreign object.

9. A method in accordance with claim 8, further comprising, during said step (a) of inserting, inserting a stiffening guide wire into a lumen extending along the length of said elongate extraction apparatus.

10. A method in accordance with claim 8, further comprising:
(d) infusing air into said patient's nasal cavity by means of a lumen extending along the length of said elongate apparatus.

11. An apparatus for extracting a foreign object lodged in a patient's nasal passageway, comprising:
a flexible, elongate body having proximal and distal ends;
an inflatable balloon segment disposed generally at said distal end of said elongate body;
a manually-actuable pump disposed at said proximal end of said elongate body in pneumatic communication with said inflatable balloon segment;
wherein said distal end of said elongate body is adapted to be inserted into said patient's nasal cavity such that said inflatable balloon segment is positioned beyond said foreign object;
and wherein actuation of said manually-actuable pump creates pneumatic pressure to inflate said balloon segment;
and wherein said elongate body is adapted to be withdrawn from said patient's nasal passageway upon inflation of said balloon segment, thereby dislodging said foreign object from said patient's nasal passageway.

12. An apparatus in accordance with claim 11, wherein said elongate body is made of an elastomeric material.

13. An apparatus in accordance with claim 12, wherein said balloon segment is integral with said elongate body.

14. An apparatus in accordance with claim 13, wherein said manually-actuable pump is integral with said elongate body.

15. An apparatus in accordance with claim 11, wherein said manually-actuable pump comprises a rubber bulb.

16. An apparatus in accordance with claim 13, wherein said balloon segment is made of ethylene vinyl acetate.

17. An apparatus in accordance with claim 11, wherein said elongate body has a first lumen extending along the length thereof providing pneumatic communication between said manually-actuable pump and said balloon segment.

18. An apparatus for extracting a foreign object lodged in a patient's nasal passageway, comprising:
a flexible, elongate body having proximal and distal ends;
an inflatable balloon segment disposed generally at said distal end of said elongate body;
an elongate lumen extending along the length of said elongate body providing pneumatic communication between said proximal end and said inflatable balloon segment;
wherein said distal end of said elongate body is adapted to be inserted into said patient's nasal cavity such that said inflatable balloon segment is positioned beyond said foreign object;
and wherein said proximal end of said elongate body is adapted to receive an end of a syringe having a plunger therein, such that depression of said plunger inflates said inflatable balloon segment;
and wherein said elongate body is adapted to be withdrawn from said patient's nasal passageway upon inflation of said balloon segment, thereby dislodging said foreign object from said patient's nasal passageway.

19. An apparatus in accordance with claim 18, wherein said elongate body is made of an elastomeric material.

20. An apparatus in accordance with claim 19, wherein said balloon segment is integral with said elongate body.

21. An apparatus in accordance with claim 22, wherein said manually-actuable pump is integral with said elongate body.

22. An apparatus in accordance with claim 18, wherein said manually-actuable pump comprises a rubber bulb.

23. An apparatus in accordance with claim 20, wherein said balloon segment is made of ethylene vinyl acetate.

24. An apparatus in accordance with claim 18, wherein said elongate body has a first lumen extending along the length thereof providing pneumatic communication between said manually-actuable pump and said balloon segment.

25. An apparatus for extracting a foreign object lodged in a patient's nasal passageway, comprising:
a flexible, elongate body having proximal and distal ends and having an elongate lumen extending along the length of said elongate body providing pneumatic communication between said proximal and distal ends;
an elastic lining disposed on said inside wall of said elongate lumen on at least a portion of said distal end of said elongate body;
an inflation port disposed at said proximal end of said elongate body;
wherein said distal end of said elongate body is adapted to be inserted into said patient's nasal cavity such that said distal end is positioned beyond said foreign object;
and wherein application of pneumatic pressure to said inflation port inflates a portion of said elastic lining out of said distal end of said elongate body in a balloon-like manner;
and wherein said elongate body is adapted to be withdrawn from said patient's nasal passageway upon inflation of said elastic lining, thereby dislodging said foreign object from said patient's nasal passageway.

26. An apparatus in accordance with claim 25, wherein said elongate body is made of an elastomeric material.

27. An apparatus in accordance with claim 25, wherein said elastic lining is made of ethylene vinyl acetate.

28. An apparatus in accordance with claim 25, further comprising a manually-actuable pump disposed at said proximal end, whereby actuation of said manually-actual pump results in said application of pneumatic pressure.

29. An apparatus for extracting a foreign object lodged in a patient's nasal passageway, comprising:
an elongate, hollow flexible outer sheath having proximal and distal ends having an elongate lumen extending along the length thereof;
an elongate, flexible balloon assembly, adapted for insertion into said lumen of said outer sheath, said balloon assembly comprising a flexible, elongate body having proximal and distal ends and having an inflatable balloon segment disposed generally at said distal end;
wherein said distal end of said outer sheath is adapted to be inserted into said patient's nasal cavity such that said distal end of said outer sheath is positioned beyond said foreign object;
and wherein said balloon assembly is adapted for insertion into said outer sheath until said inflatable balloon exits said distal end of said outer sheath;
and wherein application of pneumatic pressure at said proximal end of said balloon assembly inflates said balloon segment;
and wherein said outer sheath and balloon assembly are adapted to be withdrawn together from said patient's nasal passageway upon inflation of said balloon segment, thereby dislodging said foreign object from said patient's nasal passageway.

30. An apparatus in accordance with claim 29, wherein said elongate balloon assembly is made of an elastomeric material.

31. An apparatus in accordance with claim 29, further comprising a manually-actuable pump disposed on said proximal end of said balloon assembly.

32. An apparatus in accordance with claim 29, wherein said manually-actuable pump comprises a rubber bulb.

33. An apparatus in accordance with claim 29, wherein said balloon segment is made of ethylene vinyl acetate.

34. An apparatus in accordance with claim 31, wherein said balloon assembly has an elongate lumen extending along the length thereof providing pneumatic communication between said manually-actuable pump and said balloon segment.
